(19) United States
(12) Patent Application Publication
(10) Pub. No.: US 2007/0035098 A1
(43) Pub. Date: Feb. 15, 2007

(54) Rolling system with handle

(75) Inventor: Tom Moore, Allentown, PA (US)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Creative Strategy Group, Inc., Newtown, PA (US)

(21) Appl. No.: 11/502,669

(22) Filed: Aug. 11, 2006

Related U.S. Application Data
(60) Provisional application No. 60/707,212, filed on Aug. 11, 2005.

(51) Int. Cl. B62B 1/00

(52) U.S. Cl. 280/79.2

(57) ABSTRACT

The present invention relates to rolling system comprising a support for supporting objects, at least one wheel component having an axel, at least one guide fixedly attached to the support for receiving the axel, thereby connecting the at least one wheel component to the support, and a handle attached to the support for facilitating movement of the rolling system. Additionally, the present invention relates to a mobile package system comprising a container, a support fixedly attached to the container, at least one wheel component having an axel, at least one guide fixedly attached to the support for receiving the axel, thereby connecting the at least one wheel component to the support, and a handle attached to the support for facilitating movement of the mobile package system.

### RELATED APPLICATIONS

This application claims the benefit of U.S. Provisional Application No. 60/707,212, filed Aug. 11, 2005, entitled “ROLLING SYSTEM WITH HANDLE.”

### FIELD OF THE INVENTION

The present invention relates to a rolling system, and preferably, a flexible rolling system with a handle to assist in transporting objects.

### BACKGROUND OF THE INVENTION

Whether they are being picked up from the store, sitting in the back of a car, or just piled in the back yard, most people periodically are required to move heavy bags, awkward packages, or other objects to a desired location. Moving such bags, packages, or other objects can be burdensome, and if heavy or awkward, can be downright dangerous. Consequently, attempting to move such objects often results in dropped packages, items being broken, bags being ripped, or worse, bodily injuries.

A number of previous inventions have attempted to address these problem in a number ways. Dollies, for example, are a vastly known means for moving heavy objects. Dollies, however, are bulky, cumbersome, inflexible, difficult to control, and costly. Wheel-barrels are another example of a well known means for moving heavy objects. Like dollies, wheel-barrels can also be bulky, cumbersome, inflexible, extremely difficult to control and balance, and costly.

Presently, there are no commercially available products for moving bulky, cumbersome, heavy, or other similarly characterized objects that are themselves light, flexible and easy to use. Additionally, the majority of the existing products are quite costly and take up a good deal of space. Accordingly, it is desirable to have a system a system for transporting objects, including bulky, cumbersome, and/or heavy objects, that is itself lightweight, flexible, easily mobile, and low in cost.

### SUMMARY OF THE INVENTION

The present invention relates to a rolling system for transporting objects. The rolling system comprises a support for supporting objects, at least one wheel component having an axel, at least one guide fixedly attached to the support for receiving the axel, thereby connecting the at least one wheel component to the support, and a handle attached to the support for facilitating movement of the rolling system.

Additionally, the present invention relates to a mobile package system for storing and transporting multiple items. The mobile package system comprises a container, a support fixedly attached to the container, at least one wheel component having an axel, at least one guide fixedly attached to the support for receiving the axel, thereby connecting the at least one wheel component to the support, and a handle attached to the support for facilitating movement of the mobile package system.

### BRIEF DESCRIPTION OF THE DRAWINGS

FIG. 1 is a rolling system according to an exemplary embodiment of the present invention.

FIG. 2 is an implementation of the rolling system shown in FIG. 1.

FIG. 3 is mobile package system according to an exemplary embodiment of the present invention.

### DETAILED DESCRIPTION

It is an object of the present invention to provide a low-cost, lightweight, flexible, and easily mobile device for moving objects. It is a further object of the present invention to provide a low-cost, lightweight, flexible, and easily mobile container for moving a plurality of items contained therein.

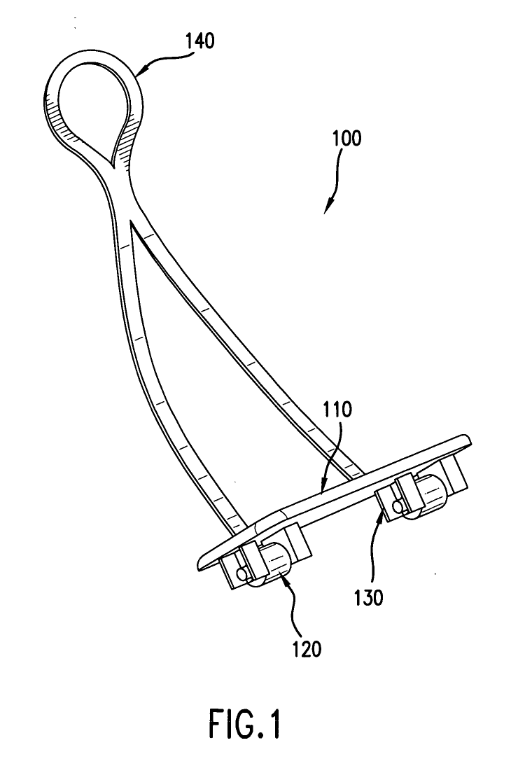

Referring now to FIG. 1, a rolling system 100 according to an exemplary embodiment of the present invention is shown. The rolling system 100 comprises a support component 110, wheel components 120, guide components 130, and a handle component 140.

The support component 110 is preferably shaped and contoured according to the particular rolling system 100 implementation. For example, the support component 110 may be flat, as shown in FIG. 1, for providing uniform support for a flat and/or rigid object, such as a box container. Alternatively, the support component 110 may comprise a v-shaped or u-shaped contour, so as to prevent less rigid or non-uniform objects from sliding off a front end of the support component 110. Large, bag-type containers, such as those used in storing large quantities of pet food, sand, mulch, fertilizer, lime, cement mix, rock salt, ice melt, charcoal, and swimming pool chemicals, and the like, are examples of objects best supported by v-shaped or u-shaped support components 110. Additionally or alternatively, the support component 110 may comprise a non-slip and/or an adhesive surface for further preventing objects from sliding off the rolling system 100. Although the support component 110 is described as having a flat and/or u-shaped contour, it should be understood that these shapes are just examples and should not be interpreted as limiting. Any desired shape and/or contour may be utilized in forming the support component 110 of the present invention.

Referring again to FIG. 1, the exemplary rolling system 100 is shown comprising two or more wheel components 120. In an alternate embodiment, however, the rolling system 100 may comprise as few as one wheel component 120, or as many as three or more such components 120. The exact number of wheel components 120 is preferably dictated by the particular implementation requirements of the rolling system 100, although any number of wheel components 120 may be utilized in accordance with the present invention. The wheel components 120 of the present invention preferably comprise one or more wheels, each having its own axel portion, as illustrated in FIG. 1. Alternatively, the wheel components 120 may comprise one or more wheel portions and a single axel disposed through a center of each of the one or more wheel portions. These axel portion(s) are preferably configured to allow the wheels to freely rotate in either a clockwise or counter-clockwise direction, thereby providing mobility to the rolling system 100.

The wheel components 120 described above are preferably attached to the support component 110 via two guide components 130. As shown in FIG. 1, each of the guide components 130 are configured to receive and secure an end of an axel portion. In this manner, the guide components 130 connect the wheel components 120 to the support component 110, thereby providing mobility to the rolling system 100. Although shown has having two separate guide components 130, the rolling system 100 of the present invention may comprise as few as one, or as many as three or more guide components 130. As with the wheel components 120, the exact number of guide components 130 is preferably dictated by the particular implementation requirements of the rolling system 100.

The rolling system 100 shown in FIG. 1 also comprises a handle component 140. The handle component 140 attaches to the support component 110 and facilitates movement of the rolling system 100. In use, force is applied to the handle 140, thereby actuating movement of the wheel components 120, which in turn, causes the support component 110, and any object support thereon, to move. Although shown as having a particular shape, it should be understood that the handle component 140 of the present invention may be configured in any desired shape and/or design suitable for facilitating movement of the rolling system 100. As with the support component 110, the handle component may optionally comprise a non-slip and/or adhesive surface for further preventing objects from sliding off the rolling system 100.

Each of the above described components of the exemplary rolling system 100 may be fixedly or removably attached to the rolling system 100. In one particular implementation, for example, it may be preferred that the handle component 140 be removably attached to the support component 110, and the guide components 130 fixedly attached to the support component 110. In such an implementation, the handle component 140 may be attached to the support component 110 via, for example, one or more slots defined in the support component 110 for receiving and securing at least one end of the handle component 140. The guide component 130 may be attached to the support component 110 via any suitable attachment means, or alternatively, the guide component 130 may be formed as part of the support component 110 via, for example, a molded construction process, wherein the support 110 and guide 130 components are formed as a single system component.

In an alternate implementation, it may be desirable that each of the handle 140, the support 110, and the guide 130 components be fixedly attached to each other. In such an implementation, these components may be constructed separately and then fixedly attached to each other via any suitable attachment means. Optionally, as discussed above, one or more of these components may be formed together as part of a compound system component, thereby eliminating the need to ‘attach’ the components together. These compound components may be formed via, for example, a molded construction process. It should be understood, however, that any suitable means for forming compound components together may be utilized in accordance with the present invention.

All components of the rolling system 100 described above are preferably formed of a light, durable material, such as plastic via a molded plastic construction process, whether separately or in combination. However, it should be understood that each and every component described herein may be formed of any desired material without departing from the spirit and scope of the present invention.

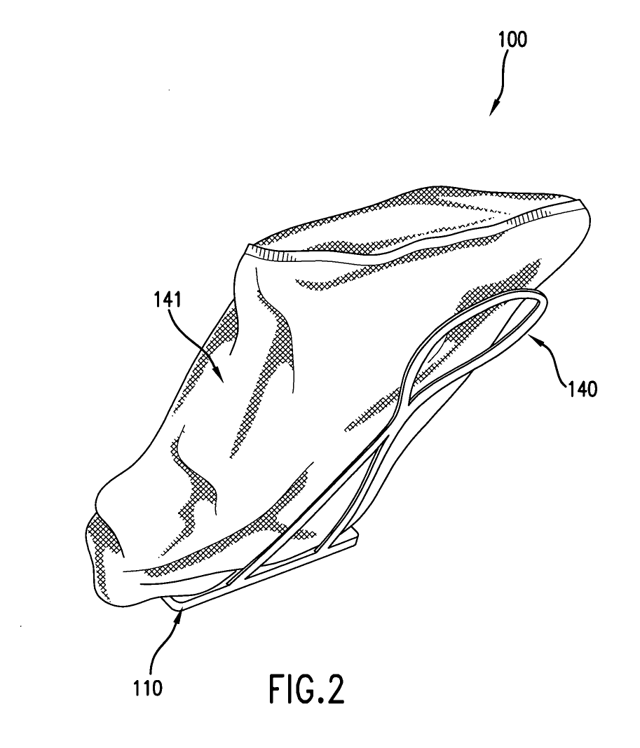

Referring now to FIG. 2, an implementation of the rolling system 100 depicted in FIG. 1 is shown. The handle component 140 is shown having a ‘figure-8’ type configuration, thereby providing further support for a large pet food container 141 being transported by the rolling system 100. As discussed above, the handle component 140 may be formed according to any desired shape and/or contour according to the particular implementation. The handle component 140 and the support component 110 further comprise optional non-slip surfaces (not shown) for further preventing the awkward bag-type container from sliding off the rolling system 100.

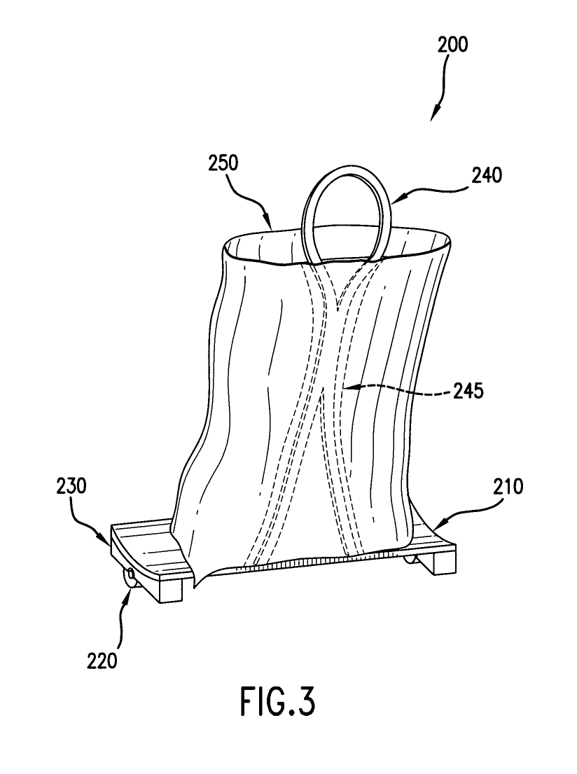

Referring now to FIG. 3, an exemplary mobile package system 200 for storing and transporting a plurality of items in accordance with the present invention is shown. The mobile package system 200 comprises a container component 250, a support component 210, wheel components 220, guide components 230, and a handle component 240.

The container component 250 is preferably constructed of a some-what flexible yet durable material, conducive for storing and transporting objects of differing shapes and sizes. Alternatively, the container component 250 may be constructed of a more rigid, protective material, for better protecting items stored therein. In either case, the shape and/or size and/or material of the container component 250 may be dictated by the particular implementation parameters. Optionally, the container component 250 may further comprise a means for fixedly attaching to the handle 240 and/or support 230 components of the system 200. As shown in FIG. 3, the container component 250 is attached to the handle component 240 via an optional handle-receiving pocket 245. Alternatively, the container component 250 may be attached to the handle 240 and or support 230 via any suitable adhesion means. The container component 250 may also be formed at part of the handle 240 and/or support 230 components via, for example, a molded construction process.

The support component 230 is preferably shaped and contoured according to the particular mobile package system 200 implementation. For example, the support component 230 may be flat, so as to provide a uniform support surface. Alternatively, the support component 230 may comprise a v-shaped or u-shaped contour, as shown in FIG. 3, for preventing less rigid or non-uniform objects, such as a bag-type container 250, from sliding off a front end of the support component 230. Additionally or alternatively, the support component 230 may comprise a non-slip and/or an adhesive surface for further preventing objects from sliding off the mobile package system 200. Although the support component 230 is described as having either a flat and/or u-shaped contour, it should be understood that these shapes are just examples and should not be interpreted as limiting. Any desired shape and/or contour may be utilized in forming the support component 230 of the present invention.

Referring again to FIG. 3, the mobile package system 200 preferably comprises two or more wheel components 220. In an alternate embodiment, however, the mobile package system 200 may comprise as few as one wheel component, or as many as three or more such components. The exact number of wheel components 220 is preferably dictated by the particular implementation requirements of the mobile package system 200, although any number of wheel components 220 may be utilized in accordance with the present invention. The wheel components 220 of the present invention preferably comprise one or more wheels, each having its own axel portion. Alternatively, the wheel components 220 may comprise one or more wheel portions and a single axel disposed through a center of each of the one or more wheel portions. These axel portion(s) are preferably configured to allow the wheels to freely rotate in either a clockwise or counter-clockwise direction, thereby providing mobility to the mobile package system 200.

The wheel components 220 described above are preferably attached to the support component 230 via two guide components (not shown). Each of these guide components are configured to receive and secure an end of an axel portion. In this manner, the guide components connect the wheel components 220 to the support component 230, thereby providing mobility to the mobile package system 200. The mobile package system 200 of the present invention may comprise as few as one, or as many as three or more guide components. As with the wheel components 220, the exact number of guide components is preferably dictated by the particular implementation requirements of the mobile package system 200.

The mobile package system 200 shown in FIG. 2 also comprises a handle component 240. The handle component 240 attaches to the support component 240 and facilitates movement of the mobile package system 200. In use, force is applied to the handle component 240, thereby actuating movement of the wheel components 220, which in turn, causes the support component 230, and the container component 250 support thereon, to move. Although shown as having a particular shape, it should be understood that the handle component 240 may be configured in any desirable shape and/or design suitable for facilitating movement of the mobile package system 200. As with the support component 230, the handle component 240 may optionally comprise a non-slip and/or adhesive surface for further preventing objects from sliding off the mobile package system 200.

Each of the above described components of the mobile package system 200 may be fixedly or removably attached to the mobile package system 200. In one particular implementation, for example, it may be preferred that the handle component 240 and the container component 250 be fixedly attached to each other, but removably attached to the support component 230. In such an implementation, the handle 240 and container 250 components may be attached to each other via the handle receiving pocket 245, with the handle-container combination being attached to the support component 230 via, for example, one or more slots defined in the support component 230 for receiving and securing at least one end of the handle component 240. Alternatively, the handle 240 and container 250 components may be formed together as part of a compound component via, for example, a molded construction process; and then attached to the support component 230 via any suitable means.

In an alternate implementation, it may be desirable that each of the handle 240, the support 230, and the container 250 components be fixedly attached to each other. In such an implementation, these components may be constructed separately and then fixedly attached to each other via any suitable attachment means. Optionally, as discussed above, one or more of these components may be formed together as part of a compound system component, thereby eliminating the need to ‘attach’ the components together. These compound components may be formed via, for example, a molded construction process. It should be understood, however, that any suitable means for forming compound components may be utilized in accordance with the present invention.

All components of the mobile package system 200 described above are preferably formed of a light, durable material such as plastic, via a molded plastic construction process, whether separately or in combination. However, it should be understood that each and every component described herein may be formed of any desired material via any desired process without departing from the spirit of the present invention.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

What is claimed is:

1. A rolling system for transporting an object, the system comprising:
a support for supporting an object;
at least one wheel component having an axel for mobilizing the support;
at least one guide fixedly attached to the support for receiving the axel, thereby connecting the at least one wheel component to the support; and
a handle attached to the support for facilitating movement of the rolling system.

2. The rolling system of claim 1, wherein the object is a container.

3. The rolling system of claim 2, wherein the support comprises one of a flat, substantially u-shaped, and substantially v-shaped support surface.

4. The rolling system of claim 2, wherein the object is a bag-type container, and wherein the support surface is contoured to support said container.

5. The rolling system of claim 1, wherein the at least one wheel component comprises two wheels and a single axel disposed through a center of each of the two wheels; and wherein the at least one guide comprises two guides, one each for receiving an end of the axel thereby connecting the two wheels to the support.

6. The rolling system of claim 1, wherein the handle is removably attached to the support, the support further comprising at least one mounting slot through which at least one end of the handle is inserted for attaching thereto.

7. The rolling system of claim 1, wherein at least one of the handle and support comprises one of a non-slip and an adhesive surface for removably attaching the object to the rolling system.

8. The rolling system of claim 1, wherein at least two of the support, the at least one guide, and the handle comprise a single system component.

9. The rolling system of claim 8, wherein the single system component is formed of a molded plastic construction process.

10. A mobile package system for storing and transporting at least one item, the package system comprising:
a container;
a support fixedly attached to the container for supporting the container;
at least one wheel component having an axel for mobilizing the support;
at least one guide fixedly attached to the support for receiving the axel, thereby connecting the at least one wheel component to the support; and
a handle fixedly attached to the container and to the support for facilitating movement of the mobile package system.

11. The mobile package system of claim 10, wherein the container is one of a rigid and flexible container.

12. The mobile package system of claim 10, wherein the container further comprises a handle-receiving pocket for attaching to the handle.

13. The mobile package system of claim 10, wherein the support comprises one of a flat, substantially u-shaped, and substantially v-shaped support surface.

14. The mobile package system of claim 10, wherein the support surface is contoured according to a contour of the container.

15. The mobile package system of claim 14, wherein the container is a bag-type container.

16. The mobile package system of claim 10, wherein the at least one wheel component comprises two wheels and a single axel disposed through a center of each of the two wheels; and wherein the at least one guide comprises two guides, one each for receiving an end of the axel thereby connecting the two wheels to the support.

17. The mobile package system of claim 10, wherein at least one of the container, the support, the at least one guide, and the handle is removably attached to the mobile package system.

18. The mobile package system of claim 10, wherein at least two of the container, the support, the at least one guide, and the handle comprise a single system component.

19. The mobile package system of claim 18, wherein the single system component is formed of a molded plastic construction process.
